(19) United States
(12) Patent Application Publication
(10) Pub. No.: US 2014/0014788 A1
(43) Pub. Date: Jan. 16, 2014

(54) CABLE ORGANIZER STRUCTURE

(71) Applicant: Kevin Fong Chen, Anaheim, CA (US)

(72) Inventor: Kevin Fong Chen, Anaheim, CA (US)

(73) Assignee: Kevin Fong Chen, Anaheim, CA (US)

(21) Appl. No.: 13/545,004

(22) Filed: Jul. 10, 2012

(51) Int. Cl. F16L 3/137

(52) U.S. Cl. 248/74.3

(57) ABSTRACT

A cable organizer structure includes a main body made of a foam material. The main body has a first end, a second end and a curled section. The curled section extends from the first end to the second end in a curled form, whereby the first end is positioned on the second end. The first end, the second end and the curled section together define a receiving space. The main body is flexible and has very good elasticity for naturally sealedly enclosing the cables. Accordingly, the cable organizer structure can be conveniently used to effectively protect the cables.

### BACKGROUND OF THE INVENTION

1. Field of the Invention

The present invention relates generally to a cable organizer structure, and more particularly to a cable organizer structure, which is flexible and has very good elasticity for naturally sealedly enclosing the cables. Accordingly, the cable organizer structure can be conveniently used to effectively protect the cables.

2. Description of the Related Art

Various electrical appliances (such as TV and DVD player) and 3C products (such as barebone computer, computer and notebook) are widely used nowadays. These electrical appliances (or 3C products) are externally connected to various periphery equipments for operations. The more the number of the externally connected peripheral equipments is, the more the number of the cables connected between the electrical appliances (or 3C products) and the periphery equipments is, such as the power cable, audio/video signal cable, display signal cable, TV cable, network cable and data transmission cable. Under such circumstance, the connection cables are likely to tangle with each other to cause a random appearance. In some more serious cases, a user may be stumbled by the connection cables. To solve the above problem, some manufacturers have developed various cable organizer structures.

The conventional cable organizer structure is made of thermosetting plastic material and has an internal receiving space for receiving the connection cables connected between the electrical appliances (or 3C products) and the periphery equipments. The cable organizer structure is able to keep the connection cables tidily arranged and prevent a user from being stumbled by the connection cables. However, the conventional cable organizer structure is made of thermosetting plastic material so that such cable organizer structure is harder and inflexible and has poor elasticity.

Therefore, the receiving space of the conventional cable organizer structure has a fixed size and cannot be expanded or contracted with the change of the number of the connection cables. In the case that there are too many connection cables, it is necessary for a user to use an additional cable organizer structure to receive the other connection cables. As a result, more room is occupied and the use cost is increased.

To save room and cost, some users often forcedly jam the same receiving space with too many connection cables. Under such circumstance, the cable organizer structure made of thermosetting plastic material will be tensioned by the connection cables to fissure. In this case, it is necessary to use a cable tie to tie up the cable organizer structure so as to seal the fissure and prevent the connection cables from dropping out of the receiving space. The above measure can save room and cost. However, the cable organizer structure jammed with the connection cables is likely to damage or even cause damage of some of the connection cables. For example, the outer protection skins of some connection cables may be worn out.

Furthermore, in the case that too few connection cables are received in the cable organizer structure made of thermosetting plastic material, the connection cables tend to slip and displace due to too small total thickness of the connection cables relative to the size of the receiving space. To solve the above problem, a user needs to use a cable tie to tie up and fix the cable organizer structure to avoid displacement of the connection cables. This leads to inconvenience in use of the cable organizer structure and increase of cost.

In addition, as aforesaid, the cable organizer structure is made of thermosetting plastic material and has a considerable hardness. Therefore, in use of the cable organizer structure, a user's fingers are likely to get injured. Also, in the case of shorter connection cables, it is difficult for a user to cut the cable organizer structure into a suitable length. Therefore, it is quite inconvenient for a user to use the conventional cable organizer structure made of thermosetting plastic material.

### SUMMARY OF THE INVENTION

It is therefore a primary object of the present invention to provide a cable organizer structure, which is flexible and has very good elasticity for naturally sealedly enclosing the cables. Accordingly, the cable organizer structure can be conveniently used.

It is a further object of the present invention to provide the above cable organizer structure, which is able to provide better protection effect for the cables so as to prevent a user's fingers from getting injured.

It is still a further object of the present invention to provide the above cable organizer structure, which is easy to cut into a necessary length by a user himself/herself as personally desired or according to the length requirement of the cables.

It is still a further object of the present invention to provide the above cable organizer structure in which the receiving space can be expanded or contracted with the change of the number of the cables fitted into the receiving space.

To achieve the above and other objects, the cable organizer structure of the present invention includes a main body made of a foam material. The main body has a first end, a second end and a curled section. The curled section extends from the first end to the second end in a curled form, whereby the first end is positioned on the second end. The first end, the second end and the curled section together define a receiving space. The main body is flexible and has very good elasticity for naturally sealedly enclosing the cables. Accordingly, the cable organizer structure can be conveniently used to effectively protect the cables.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a first embodiment of the present invention;

FIG. 2 is another perspective view of the first embodiment of the present invention;

FIG. 3 is a front view according to FIG. 2;

FIG. 4 is a perspective view of the first embodiment of the present invention, showing the use thereof in one state;

FIG. 5 is a perspective view of the first embodiment of the present invention, showing the use thereof in another state;

FIG. 6 is a perspective view of the first embodiment of the present invention, showing the use thereof in still another state;

FIG. 7 is a perspective view of the first embodiment of the present invention, showing the use thereof in still another state;

FIG. 8 is a perspective view of the first embodiment of the present invention, showing the application thereof;

FIG. 9 is a perspective view of a second embodiment of the present invention; and

FIG. 10 is a front view according to FIG. 9.

### DETAILED DESCRIPTION OF THE PREFERRED EMBODIMENTS

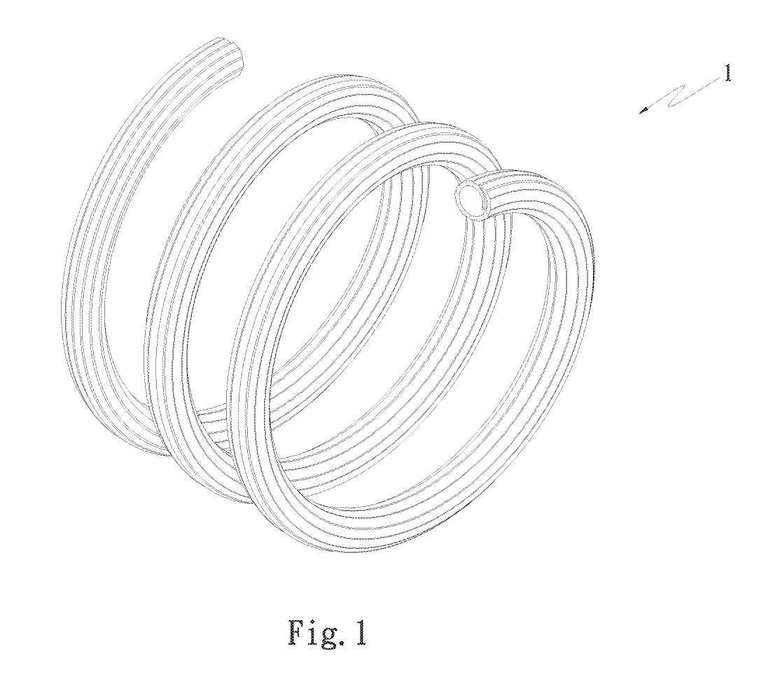

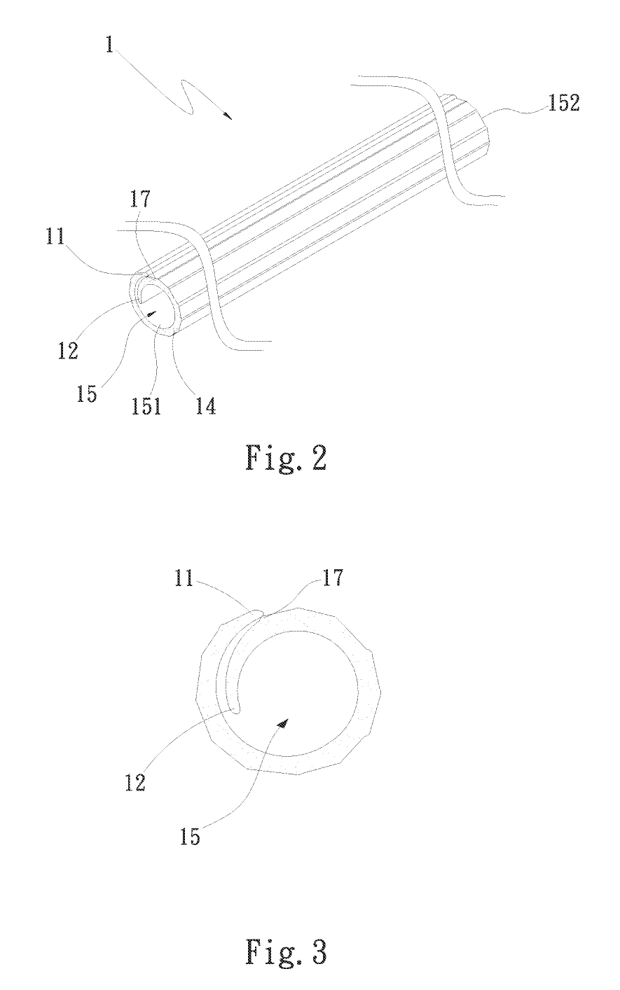

Please refer to FIGS. 1, 2 and 3. FIG. 1 is a perspective view of a first embodiment of the present invention. FIG. 2 is another perspective view of the first embodiment of the present invention. FIG. 3 is a front view according to FIG. 2. According to the first embodiment, the cable organizer structure of the present invention includes a main body 1. In this embodiment, the main body 1 is, but not limited to, an elongated tubular body for illustration purposes only. The main body 1 is made of a foam material selected from a group consisting of rubber, sponge, polyurethane (PU), polypropylene (PP), polyethylene (PE), ethylene vinyl acetate (EVA), nylon and polystyrene (PS).

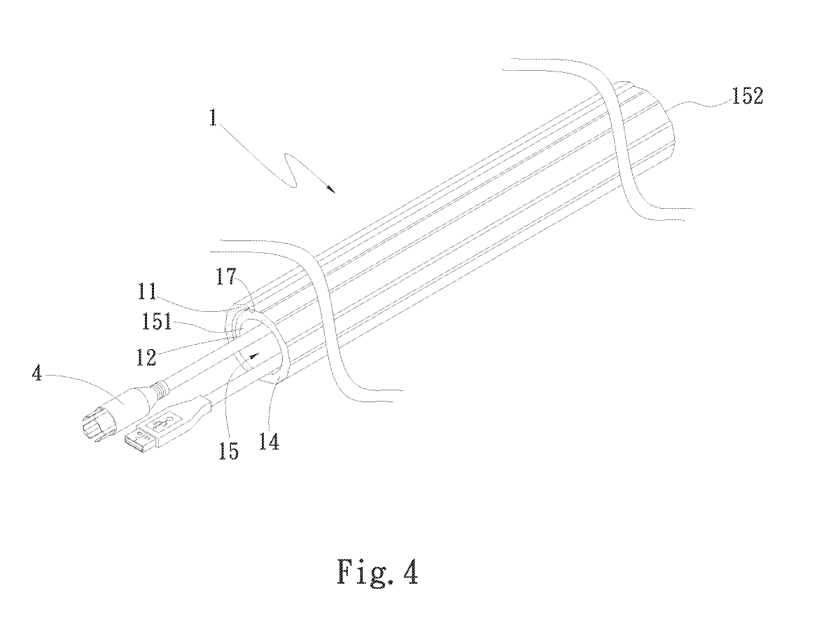

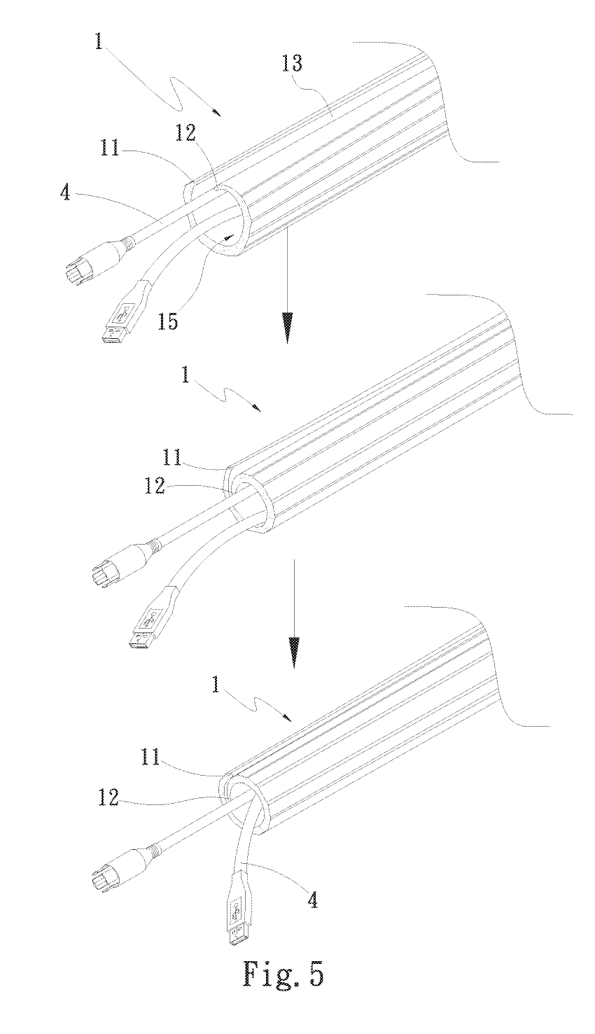

Please now refer to FIG. 4. The main body 1 has a first end 11, a second end 12 and a curled section 14. The curled section 14 extends from the first end 11 to the second end 12 in a curled form, whereby the first end 11 is positioned on the second end 12. The first end 11, the second end 12 and the curled section 14 together define a receiving space 15 for receiving at least one connection cable 4. The connection wire 4 can be a cable connected between an electrical appliance 2 (or 3C product) and an externally connected peripheral equipment 3, such as a power cable, an audio/video signal cable, a display signal cable, a TV cable, a network cable, a data transmission cable, an extension cable or the like.

The receiving space 15 has a first open side 151 and a second open side 152 in communication with the first open side. The connection cable 4 can be freely passed through the first open side 151 or the second open side 152 to be received in the receiving space 15 as shown in FIG. 4. In this case, the main body 1 can protect the connection cable 4 from being collided or damaged by alien article. In practice, alternatively, a user can force the first and second ends 11, 12 of the main body 1 away from each other to pull open the main body 1 and form a split 13 between the first and second ends 11, 12. Under such circumstance, the connection cable 4 can be placed into the receiving space 15 through the split 13. Then the first and second ends are released to elastically restore to their home positions where the first end 11 is positioned on the second end 12. In this case, the connection cable 4 is naturally sealedly enclosed in the main body 1 under protection thereof.

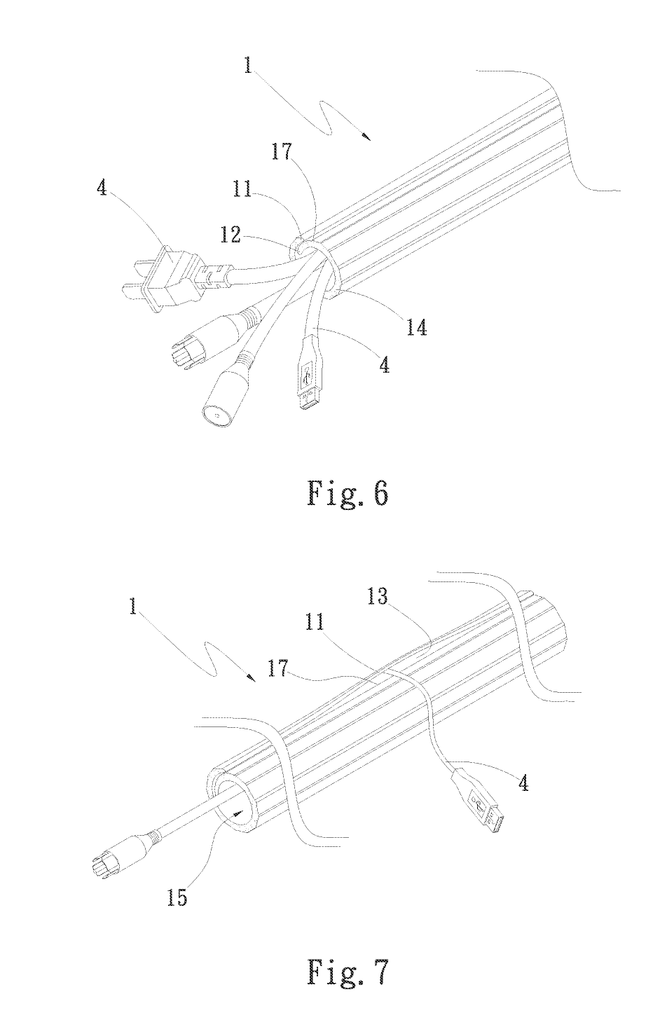

In addition, in practice, the size of the receiving space 15 is adjustable according to the number of the connection cables 4. Referring to FIG. 6, the second end 12 of the main body 1 can be moved along an inner side of the first end 11 to further curl or uncurl the curled section 14 so as to change the size of the receiving space 15.

Therefore, a user can conveniently use the cable organizer structure.

Please further refer to FIGS. 2 and 4. At least one raised section 17 is formed on an outer side of the main body 1. The raised section 17 can be a rib protruding from the outer side of the main body 1. In this embodiment, there are multiple raised sections 17 arranged on the outer side of the main body 1 at equal intervals and the first end 11 of the main body 1 is separably connected with one of the raised sections 17. In practice, the first end 11 can be separated from the raised section 17 according to the thickness of the connection cable 4 or as personally desired. After the first end 11 is disconnected from the raised section 17, the first end 11 can still attach to the raised section 17. Therefore, the size of the receiving space 15 is adjustable. In practice, the raised sections 17 can be alternatively arranged at unequal intervals.

When the cable organizer structure is applied to two connection cables 4 (such as a power cable and a TV cable), the two connection cables 4 can be snugly fitted through the receiving space 15 of the main body 1 (as shown in FIG. 4). In this case, it is unnecessary to separate the first end 11 from the raised section 17 of the main body 1. In the case that the cable organizer structure is applied to more than two connection cables 4 (such as a power cable, an audio/video signal cable, a display signal cable, a TV cable and a network cable), because the total thickness of these connection cables 4 is larger than the size of the receiving space 15, (that is, the diameter or width of the receiving space 15), it is necessary to tear apart (or pull apart) the first end 11 of the main body 1 from the raised section 17. After the first end 11 is separated from the raised section 17, the connection cables 4 can be sequentially fitted through the receiving space 15 to expand the receiving space 15 for receiving the connection cables 4 therein (as shown in FIG. 6). Accordingly, the cable organizer structure can be conveniently used to effectively protect the cables, (that is, the connection cables 4).

Moreover, according to the position of the electrical appliance 2 (or 3C product) or the positions of the respective externally connected peripheral equipments 3, the connection cables 4 can be alternatively extended out of the main body 1 from a section between two ends of the main body 1 to connect with the corresponding electrical appliance 2 (or 3C product) or the respective peripheral equipments 3. As shown in FIG. 7, the first end 11 is separated from the raised section 17 in the middle of the main body 1, whereby one of the connection cables 4 can be extended out of the main body 1 through a fissure 13 defined between the first end 11 and the raised section 17 in the middle of the main body 1 to connect with the corresponding electrical appliance 2 (or 3C product) or the peripheral equipment 3. In this case, the cable organizer structure can be conveniently used to keep the appearance tidy.

Furthermore, the main body 1 of the cable organizer structure is made of foam material and is elastically flexible and easy to use and cut. Therefore, a user can easily cut a suitable length of main body 1 as personally desired or according to the length requirement of the cables, (that is, the connection cables 4). Accordingly, the cable organizer structure can be conveniently used.

An embodiment is exemplified for illustration as follows:

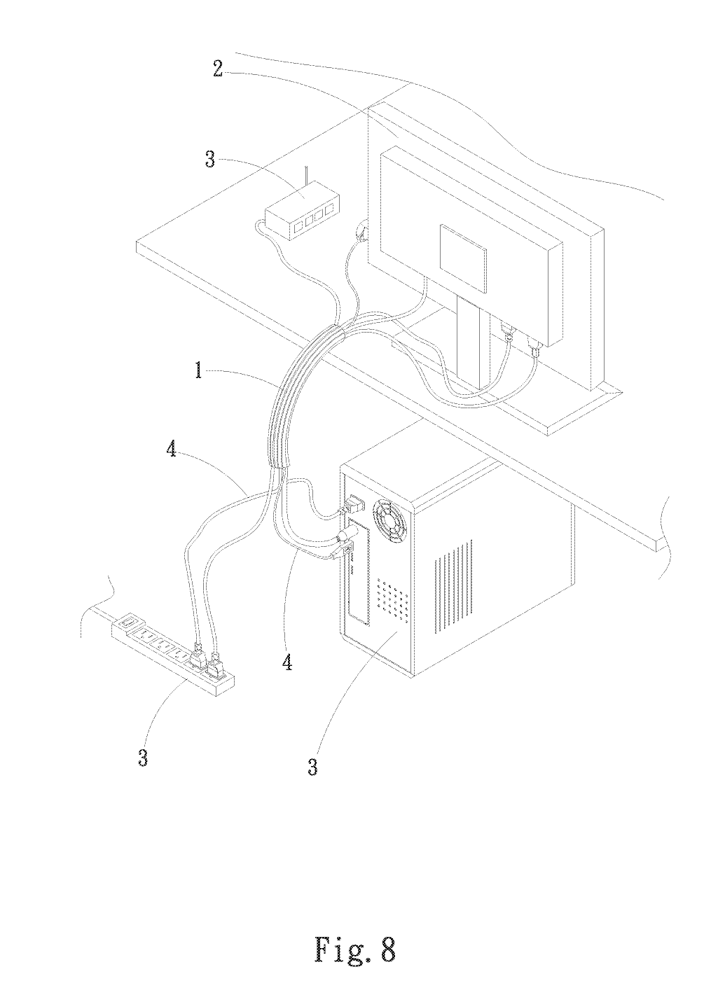

Please refer to FIGS. 2 and 8. When a user applies the cable organizer structure to the connection cables 4 between an electrical appliance 2 (such as a display screen) and the respective peripheral equipments 3 (such as a computer case, an extension cable, an IP sharer and a mouse), one end of the connection cables 4 is extended into the first open side 151 through the receiving space 15 out of the second open side 152.

Under such circumstance, the connection cables 4 are partially received in the receiving space 15 of the main body 1 under protection thereof. Accordingly, the connection cables 4 can be conveniently used and the safety in use can be ensured.

As aforesaid, the main body 1 of the present invention is made of the foam material and the first end 11 is separable from the raised section 17. Therefore, the main body 1 is flexible and has very good elasticity for naturally sealedly enclosing the connection cables 4. Accordingly, the cable organizer structure can be used to effectively protect the cables and ensure safety in use. Moreover, the cable organizer structure can be solely used without using any other auxiliary component (such as a cable tie) for tying up the main body 1 and sealing the split 13. Therefore, the cable organizer structure can be conveniently used.

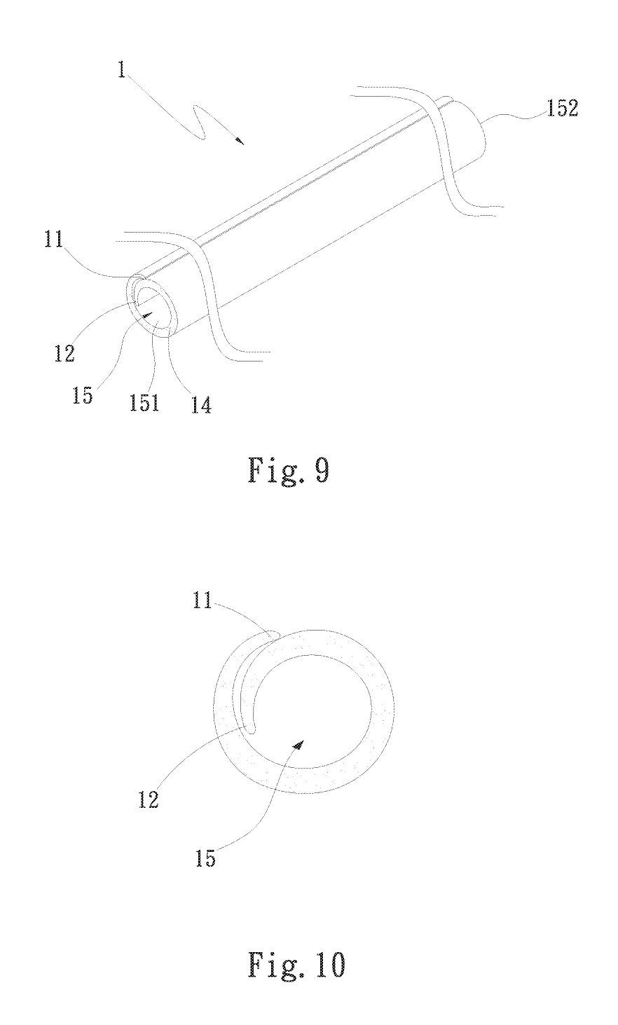

Please now refer to FIGS. 9 and 10. FIG. 9 is a perspective view of a second embodiment of the present invention. FIG. 10 is a front view of the second embodiment of the present invention. The second embodiment is substantially identical to the first embodiment in structure, connection relationship and effect and thus will not be repeatedly described hereinafter. The second embodiment is different from the first embodiment in that the second embodiment is free from the raised section 17 of the first embodiment. That is, the first end 11 of the main body 1 is separably adhered to the outer side of the curled section 14. The first end 11 is adhered to the outer side of the curled section 14 by means of adhesive adhesion, adhesive dispensing or thermal welding.

In practice, a user can disconnect and separate the first end 11 from the outer side of the curled section 14 with the first end 11 still attaching to the outer side of the curled section 14. In this case, the size of the receiving space 15 can be adjusted according to the thickness of the received connection cables 4 or as personally desired. Moreover, the first end 11 is adhered to the outer side of the curled section 14 to keep the appearance of the cable organizer structure tidy. This can save room to facilitate packaging, storage and transfer.

In conclusion, in comparison with the conventional technique, the present invention has the following advantages:
1. The present invention can be conveniently used.
2. The present invention can provide better protection effect for the cables.
3. A user himself/herself can easily cut a suitable length of main body as personally desired or according to the length requirement of the cables.
4. The safety in use is ensured.

The present invention has been described with the above embodiments thereof and it is understood that many changes and modifications in the above embodiments can be carried out without departing from the scope and the spirit of the invention that is intended to be limited only by the appended claims.

What is claimed is:

1. A cable organizer structure comprising a main body, the main body being made of a foam material, the main body having a first end, a second end and a curled section, the curled section extending from the first end to the second end in a curled form, whereby the first end is positioned on the second end, the first end, the second end and the curled section together defining a receiving space.

2. The cable organizer structure as claimed in claim 1, wherein the second end of the main body is movable along an inner side of the first end to further curl or uncurl the curled section so as to change the size of the receiving space.

3. The cable organizer structure as claimed in claim 2, wherein at least one raised section is formed on an outer side of the main body, the raised section protruding from the outer side of the main body, the first end being separably connected with the raised section.

4. The cable organizer structure as claimed in claim 3, wherein there are multiple raised sections formed on the outer side of the main body and arranged at equal intervals.

5. The cable organizer structure as claimed in claim 3, wherein there are multiple raised sections formed on the outer side of the main body and arranged at unequal intervals.

6. The cable organizer structure as claimed in claim 2, wherein the receiving space has a first open side and a second open side in communication with the first open side.

7. The cable organizer structure as claimed in claim 1, wherein the foam material is selected from a group consisting of rubber, sponge, polyurethane (PU), polypropylene (PP), polyethylene (PE), ethylene vinyl acetate (EVA), nylon and polystyrene (PS).

8. The cable organizer structure as claimed in claim 2, wherein the foam material is selected from a group consisting of rubber, sponge, polyurethane (PU), polypropylene (PP), polyethylene (PE), ethylene vinyl acetate (EVA), nylon and polystyrene (PS).

9. The cable organizer structure as claimed in claim 2, wherein the first end of the main body is separably adhered to an outer side of the curled section.

10. The cable organizer structure as claimed in claim 9, wherein the first end is adhered to the outer side of the curled section by means of adhesive adhesion, adhesive dispensing or thermal welding.
